(19) United States
(12) Patent Application Publication
(10) Pub. No.: US 2005/0183897 A1
(43) Pub. Date: Aug. 25, 2005

(54) TWO-SHOT CO-INJECTED AUTOMOTIVE INTERIOR TRIM ASSEMBLY AND METHOD

(75) Inventor: Todd L. DePue, Brighton, MI (US)

Correspondence Address: WOOD, HERRON & EVANS, LLP (LEAR), 2700 CAREW TOWER, 441 VINE STREET, CINCINNATI, OH, 45202, US

(73) Assignee: LEAR CORPORATION, Southfield, MI (US)

(21) Appl. No.: 10/708,312

(22) Filed: Feb. 24, 2004

(51) Int. Cl. B60K 37/00

(52) U.S. Cl. 180/90; 296/70; 264/46.6

(57) ABSTRACT

An automotive interior trim assembly has at least one area which provides an enhanced tactile feel that is soft to the touch. The interior trim assembly includes a substrate member and a cover member supported on the substrate member. The cover member comprises an inner foam layer which is encased by a pliable outer layer. In one embodiment, the interior trim assembly is formed in a two-shot injection molding operation wherein a first material is injected in the first shot to form the substrate member. Second and third materials are co-injected in the second shot to form the cover member on the substrate member.

### FIELD OF THE INVENTION

The present invention pertains generally to automotive interiors, and more particularly to automotive interior trim assemblies.

### BACKGROUND OF THE INVENTION

Automotive manufacturers continue to strive to provide improved automotive interiors. Accordingly, automotive interiors are typically manufactured with various trim members to enhance the aesthetic appearance of the interior. For example, automotive instrument panels or dashboards, consoles, doors and door handles are generally provided with trim panels or assemblies to improve the aesthetic appearance of these components. Conventional methods for manufacturing these trim assemblies include two-shot injection molding, wherein a first of material is injected into a mold to form a rigid substrate of the trim assembly, and a second material is injected into the mold to form a skin or cover over the rigid substrate. In certain applications, it may be desired to further improve the aesthetic appearance or functional qualities of a trim assembly by manufacturing certain areas of the trim assembly to exhibit a tactile feel that is soft to the touch. Generally, these soft-touch areas have been provided by forming a void between the skin layer and the rigid substrate during the molding process, and subsequently injecting a foam material into the void. Another conventional method involves forming a rigid substrate, placing a pre-formed foam “bun” in the area where it is desired to provide a soft-touch, and then stretching a skin layer over the rigid substrate and foam bun.

These prior methods of forming trim assemblies are manufacturing intensive, requiring multiple operations and/or manual labor to produce the soft-touch trim assemblies. The increased number of operations and manual labor result in increased manufacturing costs and inconsistent quality of the resulting trim assemblies. A need therefore exists for an automotive trim assembly having a soft-touch feel which overcomes these and other drawbacks of the prior art.

### SUMMARY OF INVENTION

The present invention provides an automotive interior trim assembly that improves the aesthetic appearance of an automotive interior by having areas that are soft to the touch, but which can be produced in an efficient and cost-effective manner. The trim assembly can be an instrument panel, an interior door trim, an armrest, a console, or any other interior trim component that would benefit from having at least some areas which are soft to the touch.

In one embodiment, the interior trim assembly comprises a substrate member having at least one target area for providing a soft feel to the trim assembly, and a cover member supported on the substrate member proximate the target area. The substrate member forms at least part of the structural support for the trim assembly and the cover member includes an inner layer of foam material encased in an outer layer of pliable material. When a force is applied to the cover member, the outer layer will deform and compress the inner layer, providing a soft-touch feel to the trim assembly.

In another embodiment, the trim assembly is formed by a two-shot molding operation. A first material is injected into a mold during the first shot to form the substrate member. Second and third materials are co-injected during the second shot to form the cover member, wherein the second material forms a skin over the third material to completely encase the third material.

The features and objectives of the present invention will become more readily apparent from the following detailed description taken in conjunction with the accompanying drawings.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the invention.

FIG. 1 is a cross-sectional view of an exemplary automotive interior trim assembly according to the present invention; and

FIGS. 2-4 are schematic cross-sectional views depicting the manufacture of the trim assembly of FIG. 1.

### DETAILED DESCRIPTION

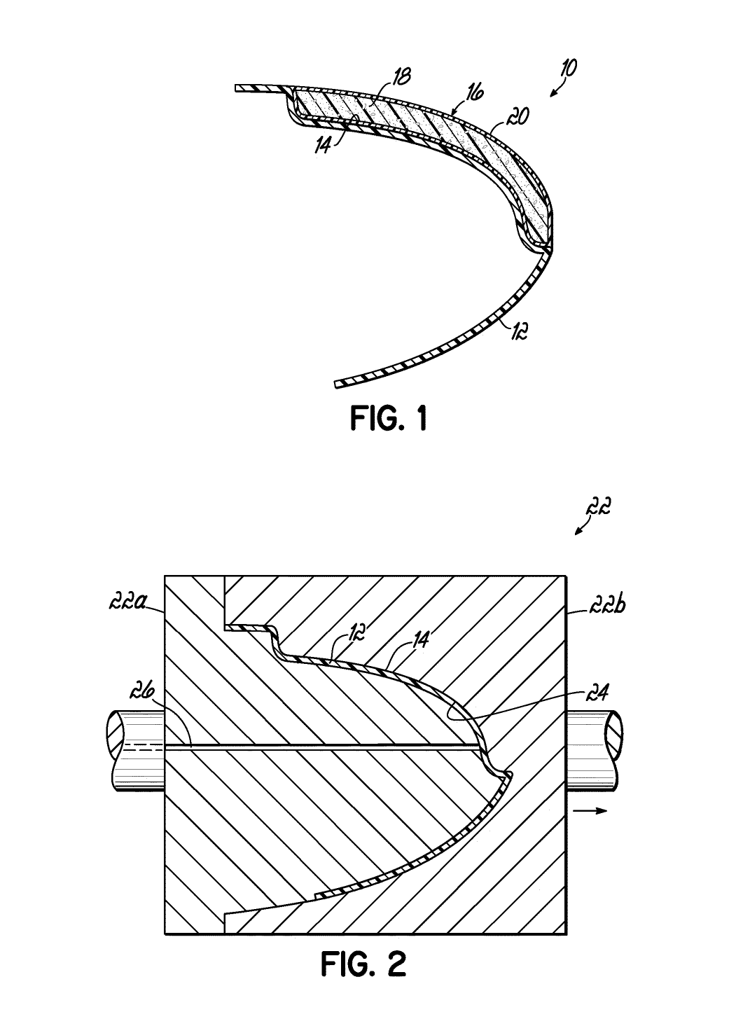

Referring to FIG. 1, there is shown an exemplary automotive interior trim assembly according to the present invention. In this embodiment, the interior trim assembly is depicted as an automotive instrument panel, or dashboard 10 (in cross section), having a relatively rigid substrate member 12 which forms the structural frame of the trim assembly. The substrate member 12 has at least one area 14 for receiving a cover member 16 which provides a soft-touch feel to the instrument panel 10. To provide the improved soft-touch feel, the cover member 16 comprises an outer layer 20 formed from a material which is softer, or more pliable, than the material of the substrate member 12 and has an inner layer 18 of foam or cushion material which is encased by the outer layer of pliable material 20 to form a skin over the inner layer 18. Because the outer layer 20 of the cover member 16 is relatively pliable, the outer layer 20 will deform and compress the inner layer 18 when a force is applied to the outer layer 20, thereby enhancing the soft-touch feel of that portion of the instrument panel 10 which is covered by cover member 16.

In one embodiment, the instrument 10 is formed by injection molding and the substrate material is thermoplastic olefin, acrylonitrile butadiene styrene, styrene maleic anhydride, polycarbonate/acrylonitrile butadiene styrene alloy, or any other suitable material suitable for molding the relatively rigid substrate member 12. The outer layer 20 of the cover member 16 is formed from a material which is softer, or has a relatively lower hardness than the material used to form the substrate member 12, such as thermoplastic elastomer. The inner layer 18 of the cover member 16 is a foam material, such as thermoplastic elastomer foam.

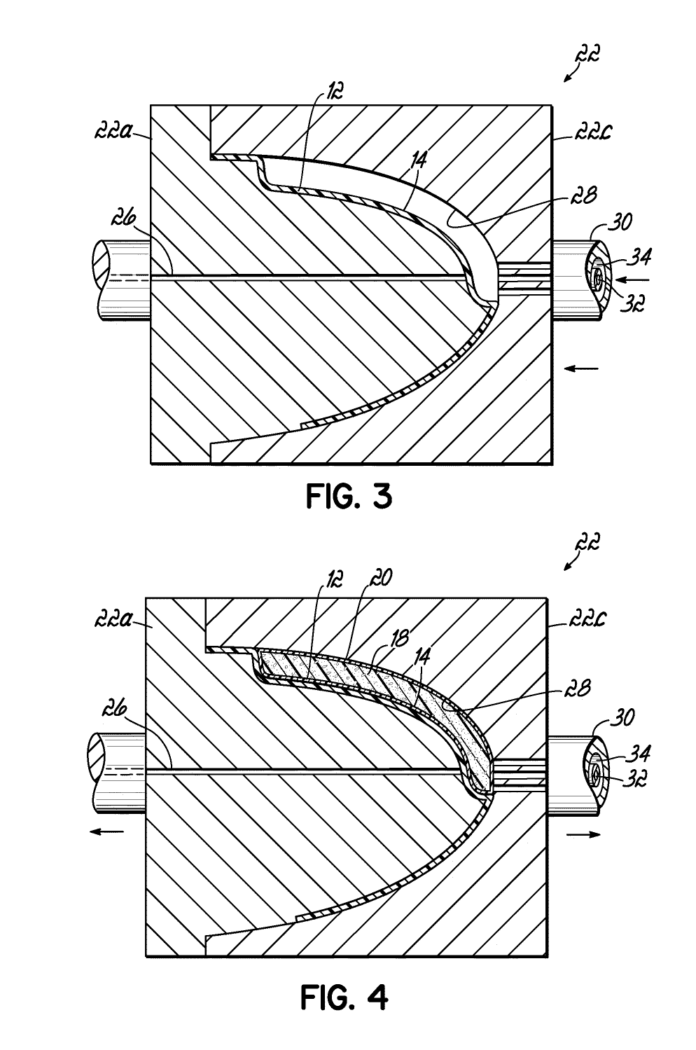

In another embodiment, the automotive interior trim assembly of the present invention is formed in a two-shot molding operation, as will be described with reference to FIGS. 2-4. As shown in FIG. 2, the substrate member 12 of instrument panel 10 is formed during the first shot of a two-shot molding operation by injecting a first material into a mold 22 configured to form the substrate member 12. In the embodiment shown, mold 22 comprises first and second halves 22a, 22b which may be assembled together to define an interior cavity 24 having the general shape of the substrate member 12. The first material is injected into the cavity 24 through a sprue 26 as known in the art. After the first material has been injected into the mold 22 to form the substrate member 12, the second mold portion 22b is removed and replaced with a third mold portion 22c which is configured such that the first and third mold portions 22a, 22c define a cavity 28 for forming the cover member 16 during the second shot of the two-shot mold process. As seen in FIG. 3, the substrate member 12 is retained in the mold 22 so that the cover member 16 may be formed directly on the target area 14 during the second shot of the molding operation. The third mold portion 22c includes at least one sprue member 30 having first and second annular sprues 32, 34, whereby second and third materials may be co-injected into cavity 28 to form the cover member 16, as shown in FIG. 4. Advantageously, the co-injected second and third materials form the cover member 16 such that the second material forms the outer, skin layer 20 of the cover member 16 and the third material forms the inner, foam layer 18 of the cover member 16. In one embodiment, the inner foam layer 18 is completely encased within the outer skin layer 20. The finished instrument panel 10 is thereafter removed from the mold 22.

While the interior trim assembly has been shown and described herein as an instrument panel 10, it will be recognized that the interior trim assembly of the present invention may alternatively be formed to create a door trim panel, an armrest, a door handle, a console, or other interior components of an automobile.

While the present invention has been illustrated by the description of an exemplary embodiment thereof, and while the embodiment has been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. An automotive interior trim assembly, comprising:
a substrate member forming at least part of a structural support of the trim assembly and having at least one target area for providing a soft feel to the trim assembly; and
a cover member supported on said substrate member, proximate said target area, said cover member having a hardness that is relatively lower than said substrate member and comprising an inner compressible layer and an outer pliable layer encasing said inner layer.

2. The trim assembly of claim 1, wherein said substrate member is formed from one of thermoplastic olefin, acrylonitrile butadiene styrene, styrene maleic anhydride, and polycarbonate/ acrylonitrile butadiene styrene alloy.

3. The trim assembly of claim 1, wherein said inner layer of said cover member is formed from thermoplastic elastomer foam.

4. The trim assembly of claim 1 configured as an instrument panel for an automobile.

5. A method of forming an automotive interior trim assembly in a two-shot molding operation, the method comprising:
injecting a first material to form a substrate member during the first shot of the molding operation; and
co-injecting second and third materials onto the substrate member to form a cover member on the substrate member during the second shot of the molding operation.

6. The method of claim 5, wherein the second material is an outer pliable layer and the third material in an inner compressible layer, and the method further comprises:
covering the inner compressible layer with the outer pliable layer during the co-injecting step.

7. The method of claim 5, wherein the first material is one of thermoplastic olefin, acrylonitrile butadiene styrene, styrene maleic anhydride, and polycarbonate/acrylonitrile butadiene styrene alloy.

8. The method of claim 5, wherein the second material is thermoplastic elastomer.

9. The method of claim 5, wherein the third material is thermoplastic elastomer foam.
